(19) United States
(12) Patent Application Publication
(10) Pub. No.: US 2025/0122127 A1
(43) Pub. Date: Apr. 17, 2025

(54) METHOD FOR PREPARING CERAMIC STRIP HEATER WITH IMPROVED FIXING EFFECT

(71) Applicant: Sinoceram Technology (zhengzhou) Co., Ltd., Zhengzhou (CN)

(72) Inventors: Xiao CHEN, Zhengzhou (CN); Liping KONG, Zhengzhou (CN); Chongjun WU, Zhengzhou (CN); Yujie ZHENG, Zhengzhou (CN); Xiaoquan ZHENG, Zhengzhou (CN)

(21) Appl. No.: 18/989,491

(22) Filed: Dec. 20, 2024

(30) Foreign Application Priority Data
Dec. 21, 2023 (CN) 202311772555.3

(51) Int. Cl. C04B 41/45; C03C 3/066; C03C 8/04; C04B 35/10; C04B 41/00; C04B 41/50; C04B 41/51; C04B 41/52; C04B 41/86; C04B 41/88; G03G 15/20

(52) U.S. Cl. CPC C04B 41/4574; C03C 3/066; C03C 8/04; C04B 35/10; C04B 41/0072; C04B 41/4539; C04B 41/5022; C04B 41/5111; C04B 41/52; C04B 41/86; C04B 41/88; G03G 15/2053; C03C 2205/00

(57) ABSTRACT

A method for improving fixing effect of a ceramic strip heater is performed as follows. An electrode material is applied to each end of an upper surface of an alumina ceramic substrate by printing, followed by drying and sintering to form an electrode. A heating paste is applied to the upper surface of the alumina ceramic substrate by printing to connect two electrodes on both ends of the alumina ceramic substrate, followed by drying and sintering to form a heating filament. A glass paste is applied to a lower surface of the alumina ceramic substrate by printing, followed by drying and sintering to form a first glass layer. Another glass paste is applied onto the heating paste by printing, followed by drying and sintering to form a second glass layer, so as to arrive at the ceramic strip heater.

### CROSS-REFERENCE TO RELATED APPLICATIONS

This application claims the benefit of priority from Chinese Patent Application No. 202311772555.3, filed on Dec. 21, 2023. The content of the aforementioned application, including any intervening amendments thereto, is incorporated herein by reference in its entirety.

### TECHNICAL FIELD

This application relates to ceramic strip heaters, and more particularly to a method for preparing a ceramic strip heater with an improved fixing effect.

### BACKGROUND

The heating components in the existing laser printer fuser units mainly include tungsten heating tube and ceramic strip heater.

The traditional laser printers generally adopt a heating tube as a heating component in the fuser unit, in which a tungsten filament can be energized to generate heat. Compared to the tungsten filament heating, the ceramic strip heater has characteristics of fast heating speed, uniform heating, short first print-out time and long service life, and thus has been gradually popularized.

The ceramic strip heater is composed of a ceramic substrate, an electrode, a heating filament and a glass glaze, where the heat filament is energized to emit heat, and the heat is transmitted through the glass layer to melt the toner powder adsorbed on a printing medium through pressure hot-melting, such that the melted toner powder is inlaid to form a fixed print file. Compared to a lamp tube, the ceramic substrate has characteristics of good thermal conductivity, high thermal conductivity rate and high temperature resistance, accelerating the heat dissipation of the whole heating device.

Although the ceramic strip heater has many advantages, there are still technical problems about the use safety and reliability. Regarding the ceramic strip heater, an alumina ceramic substrate has a thermal conductivity of ≥21 W(m*K), while a thermal conductivity of the upper glass glaze layer is only 2-5 W(m*K) (that is, the thermal conductivity of the alumina ceramic substrate is 4-10 times that of the upper glass glaze layer), such that the generated heat is prone to be transmitted by the ceramic substrate, and less heat is transmitted through the glass glaze in contact with the printing paper, leading to a poor fixing level. Owing to the large difference between the ceramic substrate and the glass glaze, most of the heat is dissipated through the alumina ceramic substrate, resulting in the waste of heat. Therefore, in order to realize the desired fixing effect, a glass glaze with high thermal conductivity is preferred, which will inevitably increase the production cost.

### SUMMARY

An object of this application is to provide a method for preparing a ceramic strip heater with an improved fixing effect, which can effectively solve the problem that the existing ceramic strip heaters fail to offer a desired fixing effect.

Technical solutions of this application are described as follows.

A method for preparing a ceramic strip heater is provided, comprising:
(S1) applying an electrode material on each of two ends of an upper surface of an alumina ceramic substrate by printing, followed by drying and sintering to form an electrode;
(S2) applying a heating paste onto the upper surface of the alumina ceramic substrate by printing to connect two electrodes on the two ends of the upper surface of the alumina ceramic substrate, followed by drying and sintering to form a heating filament;
(S3) applying a first glass paste onto a lower surface of the alumina ceramic substrate by printing, followed by drying and sintering to form a first glass layer; and
(S4) applying a second glass paste onto the heating filament by printing, followed by drying and sintering to form a second glass layer, so as to produce the ceramic strip heater.

In an embodiment, in step (S1), a main component of the electrode material is AgPt.

In an embodiment, in step (S1), a temperature of the drying is 100-150° C., and a temperature of the sintering is 830-880° C.

In an embodiment, in step (S2), a main component of the heating paste is AgPt; and a temperature coefficient of resistance (TCR) of the heating paste is 200-600 ppm/° C.

In an embodiment, in step (S2), a temperature of the drying is 100-150° C., and a temperature of the sintering is 830-880° C.

In an embodiment, in step (S3), a solid part of the first glass paste comprises higher than 40 wt. % of Al₂O₃, 18 wt. % of SiO₂, 15 wt. % of B₂O₃, 5 wt. % of ZnO and 15 wt. % of BaO; and a solid content of the first glass paste is 70 wt. %.

In an embodiment, in step (S4), a solid part of the of the second glass paste comprises higher than 40 wt. % of Al₂O₃, 18 wt. % of SiO₂, 15 wt. % of B₂O₃, 5 wt. % of ZnO and 15 wt. % of BaO; and a solid content of the second glass paste is 70 wt. %.

In an embodiment, in steps (S3)-(S4), a temperature of the drying is 100-150° C., and a temperature of the sintering is 800-860° C.

In an embodiment, in step (S3), the first glass paste is applied in 1 layer by a 325-mesh 40-μm screen, and a thickness of the first glass layer is 8-10 μm.

In an embodiment, in step (S4), the second glass paste is applied in 5-7 layers by a 200-mesh 40-μm screen; and a total thickness of the second glass layer is 60-80 μm.

In an embodiment, in order to avoid surface quality impact caused by the first glass layer directly touching a kiln roller conveyor, in step (S4), the first glass layer is placed on a support during the sintering of the second glass layer.

In an embodiment, the support comprises a base plate and at least two beams; and the at least two beams are arranged in parallel at upper surfaces of two ends of the base plate, respectively.

In an embodiment, the two beams are fixedly connected to an upper surface of the base plate.

Compared to the prior art, this application has the following beneficial effects.

Regarding the preparation method provided herein, the first glass layer is applied to the lower surface of the alumina ceramic substrate by printing to slow down the heat dissipation of the alumina ceramic substrate, such that more heat is transmitted from the second glass layer on the upper surface of the alumina ceramic substrate, improving the heating effect and the fixing effect. In addition, compared to the application of a glass layer with a high thermal conductivity on the upper surface, the production cost is remarkably reduced. In this application, a glass layer is applied to the lower surface of the ceramic substrate through printing and sintering, and then another glass layer is applied to the upper surface through printing and sintering, so as to avoid the extension, size increase and edge irregularity of the glass layer on the upper surface caused by repeated firing.

### BRIEF DESCRIPTION OF THE DRAWINGS

FIG. 1 is a structural diagram of a ceramic strip heater according to an embodiment of the present disclosure.

FIG. 2 is a structural diagram of a support according to an embodiment of the present disclosure.

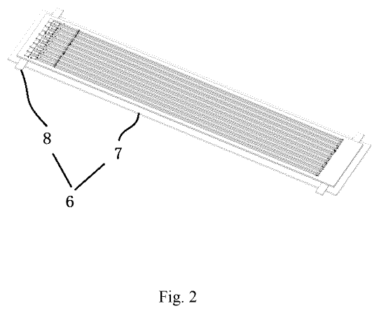

In Figures: 1, first glass layer; 2, alumina ceramic substrate; 3, electrode; 4, heating filament; 5, second glass layer; 6, support; 7, base plate; and 8, beam.

### DETAILED DESCRIPTION OF EMBODIMENTS

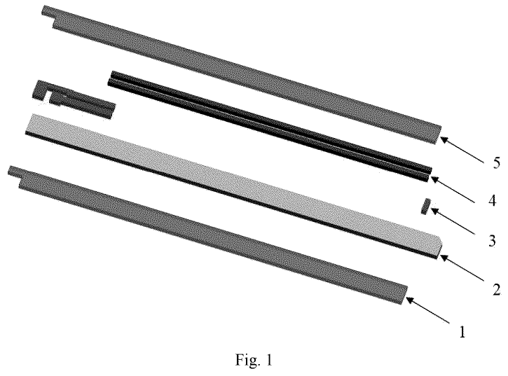

The present disclosure provides a method for preparing a ceramic strip heater with improved fixing effect (as shown in FIG. 1), including the following steps.
(S1) An electrode material is applied to each of two ends of an upper surface of an alumina ceramic substrate 2 by printing, where a main component of the electrode material is AgPt. The electrode material is a paste with uniform color and good weldability. After the printing, the alumina ceramic substrate 2 is dried in a drying oven at 100-150° C., and sintered at 830-880° C. in a sintering furnace to form an electrode 3, which is silvery and glossy.
(S2) A heating paste is applied onto the upper surface of the alumina ceramic substrate 2 by printing to connect two electrodes 3 on the two ends of the upper surface of the alumina ceramic substrate 2. A main component of the heating paste is AgPt, and the heating paste is uniform color paste. A temperature coefficient of resistance (TCR) of the heating paste is 200-600 ppm/° C. After that, the alumina ceramic substrate 2 is dried in the drying oven at 100-150° C., and sintered at 830-880° C. in the sintering furnace to form a heating filament 4, which is configured to generate heat after energization. The heating filament 4 is examined to ensure that there is no short circuit and open circuit at the surface. In addition, a resistance of the heating filament 4 is detected by a resistance tester.
(S3) A first glass paste is applied onto a lower surface of the alumina ceramic substrate 2 by printing to slow down heat dissipation from the lower surface of the alumina ceramic substrate 2, where a solid part of the first glass paste includes higher than 40 wt. % of Al₂O₃, 18 wt. % of SiO₂, 15 wt. % of B₂O₃, 5 wt. % of ZnO and 15 wt. % of BaO, and a solid content of the first glass paste is 70 wt. %. The first glass paste is applied in 1 layer by a 325-mesh 40-μm screen, and a thickness of the first glass layer is 8-10 μm. After printing, the alumina ceramic substrate 2 is placed in the 100-150° C. drying box to dry, followed by sintering in the sintering furnace to form a first glass layer 1, where a temperature of the sintering is 800-860° C. After sintering, the first glass layer 1 is uniform and transparent. Specifically, for the formation of the first glass layer 1, an edge of the alumina ceramic substrate 2 has a protective edge with a width of 4 mm which is not coated with the first glass paste, that is, not the whole lower surface of the alumina ceramic substrate 2 is coated with the first glass paste.
(S4) A second glass paste is applied onto the heating paste in 5-7 layers by printing for insulation and heat conduction. A solid part of the second glass paste is the same as the first glass paste in step (S3). The second glass paste is applied in 5-7 layers by using a 200-mesh 40-μm screen, and a total thickness of the second glass layer is 60-80 μm. After that, the alumina ceramic substrate 2 is dried in the drying oven at 100-150° C., and sintered at 800-860° C. in the sintering furnace to form a second glass layer 5.

In this embodiment, in order to avoid surface quality impact caused by the first glass layer 1 directly touching a kiln roller conveyor, in step (S4), the first glass layer 1 is placed on a support 6 during the sintering of the second glass layer 5. The support 6 includes a base plate 7 and at least two beams 8. Two beams 8 are arranged in parallel at upper surfaces of two ends of the base plate 7, respectively. An edge of each of two ends of the alumina ceramic substrate 2 has a protective edge with a width of 4 mm which is not coated with the second glass paste. A distance between the two beams 8 is larger than a length of the first glass layer 1. Specifically, during the sintering, a bottom surface of the base plate 7 is placed on the kiln roller conveyor, and the protective edge is placed on the two beams 8, so as to prevent the first glass layer 1 from contacting the support 6, which will affect the surface quality of the first glass layer 1 during the sintering. In other embodiments, the two beams 8 are arranged in parallel at the upper surfaces of two ends of the base plate 7. The edge of each of two ends of the alumina ceramic substrate 2 has a protective edge with a width of 4 mm which is not coated with the second glass paste, respectively. The distance between the two beams 8 is larger than a width of the first glass layer 1. In other embodiments, the two beams 8 are arranged in parallel at the two ends of the base plate 7 or the upper surfaces of two ends of the base plate 7. An edge around the alumina ceramic substrate 2 has a protective edge with a width of 4 mm which is not coated with the second glass paste.

What is claimed is:

1. A method for preparing a ceramic strip heater, comprising:
(S1) applying an electrode material on each of two ends of an upper surface of an alumina ceramic substrate by printing, followed by drying and sintering to form an electrode;
(S2) applying a heating paste onto the upper surface of the alumina ceramic substrate by printing to connect two electrodes on the two ends of the upper surface of the alumina ceramic substrate, followed by drying and sintering to form a heating filament;
(S3) applying a first glass paste on a lower surface of the alumina ceramic substrate by printing, followed by drying and sintering to form a first glass layer; and
(S4) applying a second glass paste on the heating filament by printing, followed by drying and sintering to form a second glass layer, so as to produce the ceramic strip heater.

2. The method of claim 1, wherein in step (S1), a main component of the electrode material is AgPt.

3. The method of claim 2, wherein in step (S1), a temperature of the drying is 100-150° C., and a temperature of the sintering is 830-880° C.

4. The method of claim 1, wherein in step (S2), a main component of the heating paste is AgPt; and a temperature coefficient of resistance (TCR) of the heating paste is 200-600 ppm/° C.

5. The method of claim 4, wherein in step (S2), a temperature of the drying is 100-150° C., and a temperature of the sintering is 830-880° C.

6. The method of claim 1, wherein in step (S3), a solid part of the first glass paste comprises higher than 40 wt. % of Al₂O₃, 18 wt. % of SiO₂, 15 wt. % of B₂O₃, 5 wt. % of ZnO and 15 wt. % of BaO; and a solid content of the first glass paste is 70 wt. %; and
in step (S4), a solid part of the second glass paste comprises higher than 40 wt. % of Al₂O₃, 18 wt. % of SiO₂, 15 wt. % of B₂O₃, 5 wt. % of ZnO and 15 wt. % of BaO; and
a solid content of the second glass paste is 70 wt. %.

7. The method of claim 6, wherein in steps (S3)-(S4), a temperature of the drying is 100-150° C., and a temperature of the sintering is 800-860° C.

8. The method of claim 7, wherein in step (S3), the first glass paste is applied in 1 layer by a 325-mesh 40-μm screen, and a thickness of the first glass layer is 8-10 μm.

9. The method of claim 7, wherein in step (S4), the second glass paste is applied in 5-7 layers by a 200-mesh 40-82 m screen; and a total thickness of the second glass layer is 60-80 μm.

10. The method of claim 1, wherein in step (S4), the first glass layer is placed on a support during the sintering of the second glass layer.

11. The method of claim 10, wherein the support comprises a base plate and at least two beams; and the at least two beams are arranged in parallel at upper surfaces of two ends of the base plate, respectively.
